(19) United States
(12) Patent Application Publication
(10) Pub. No.: US 2001/0022818 A1
(43) Pub. Date: Sep. 20, 2001

(54) Work machine control system

(76) Inventors: Noritaka Nagata, Hiratsuka-shi (JP); Teruaki Arakawa, Tokyo (JP)

Correspondence Address: VARNDELL & VARNDELL, PLLC, 106-A SOUTH COLUMBUS STREET, ALEXANDRIA, VA, 22314, US

(21) Appl. No.: 09/795,400

(22) Filed: Mar. 1, 2001

(30) Foreign Application Priority Data
Mar. 17, 2000 (JP) 077295/2000

(51) Int. Cl. H04L 27/00

(52) U.S. Cl. 375/259

(57) ABSTRACT

A controller unit is made so that a work machine can be remotely controlled in a reliable manner irrespectively of whether the controller unit is used outdoors or indoors. Inside the controller unit 10 is provided a transmitter 11 that inputs a control signal S0 indicating the control content, converts the input control signal S0 to a radio signal Se and radio-transmits it toward the work machine 13. The work machine 13 operates according to the radio signal Se radio-transmitted from the transmitter 11. Meanwhile, a transmitter 12 similar to the internal transmitter 11 is provided externally to the controller unit 10. Thereupon, when the external transmitter 12 is connected to the controller unit 10, it is determined by a determining unit 14 inside the controller unit 10 that the external transmitter 12 is connected to the controller unit 10. When it is determined by the determining unit 14 that the external transmitter 12 is connected to the controller unit 10, the control signal S0 is switched by switching units 15 and 16 inside the controller unit 10 from sides 15a and 16a where the control signal S0 is inputted to the transmitter 11 inside the controller unit 10 to sides 15b and 16b where the control signals S0 is inputted to the transmitter 12 provided externally to the controller unit 10.

### BACKGROUND OF THE INVENTION

1. Field of the Invention

This invention relates to a work machine control system. More particularly, the present invention relates to a work machine control system wherewith a work machine can be remotely operated, in a definite manner, without radio signals attenuating, irrespective of whether a controller unit is located outdoors or indoors.

2. Description of the Related Art

When roads or rivers are blocked by bedrock collapse or landslides caused by heavy rain or earthquake, it is necessary to effect restoration quickly. Also, such restoration work must be done in the shortest time possible while protecting operators or workers from secondary disaster.

To cope with this necessity of performing work in the shortest time possible at such hazardous work sites, technology for operating work machines remotely by radio control has been conventionally adopted. By remote operations with radio control, work can be done while keeping operators and workers distant from hazardous sites where secondary disasters are anticipated.

FIG. 6(a) and 6(b) are diagrams representing a conventional work machine remote control system.

FIG. 6(a) is a diagram representing a case where a work machine is operated remotely outdoors, while FIG. 6(b) is a diagram representing a case where a work machine is operated remotely indoors.

A description if given first of the work machine remote control system diagrammed in FIG. 6(a).

Levers and switches and the like manipulated by an operator are provided on a control panel on the outside of a controller unit 70.

An internal transmitter 11 is provided inside the controller unit 70.

The internal transmitter 11 inputs a control signal indicating how the operator has manipulated a lever or switch, converts the input control signal to a radio signal Se, and radio-transmits that toward a work machine 13.

A receiver 30 for receiving the radio signal Se is provided internally in the work machine 13.

Thus the radio signal Se transmitted from the internal transmitter 11 is received by the receiver 30, a control signal is extracted from the received radio signal Se, and the work machine 13 is operated in response to that control signal.

The remote control system diagrammed in FIG. 6(a) is used under circumstances where the controller unit 70 is portably carried and the work machine 13 is remotely controlled with good mobility. That is, The operator carries the controller unit 70 with him or her, and remotely controls the work machine 13 with the controller unit 70 while successively moving to places from where the work machine 13 can be remotely controlled visually.

Next, the remote control system diagrammed in FIG. 6(b) is described.

In FIG. 6(b), a controller unit 71 is located inside a building 72. An external transmitter 12 is provided on the outside of the controller unit 71. The external transmitter 12 has the same functions as the internal transmitter 11 of FIG. 6(a). However, the external transmitter 12 is located outside of the building 72. The reason for this is that, when a radio signal Se is transmitted as a radio wave from inside the building 72, the radio wave is attenuated or shielded by the walls or roof of the building 72, making transmission to the work machine 13 very difficult.

In other words, the controller unit 71 inside the building 72 is connected by a cable with the external transmitter 12 on the outside of the building 72. A control signal output from the controller unit 71 is input to the external transmitter 12 over the cable. Then a radio signal Se is transmitted from the external transmitter 12. The radio signal Se is received by the receiver 30 provided in the work machine 13 and the work machine 13 is thereby operated.

The remote control system diagrammed in FIG. 6(b) is used under circumstances such that remote control is effected inside the building 72 where it is safe, with the operator distanced from the hazardous outside environment.

Operators would prefer to employ a controller unit differently, according to changes in the environment, that is, either carrying the controller unit portably and effecting control outdoors, or operating the controller unit inside the building, depending on the case.

However, if the controller unit 70 diagrammed in FIG. 6(a) is taken inside the building 72, radio waves transmitted from the internal transmitter 11 provided inside the controller unit 70 will be attenuated or shielded by the walls or roof of the building 72, making transmission to the work machine 13 very difficult.

Conversely, if the controller unit 71 diagrammed in FIG. 6(b) is carried outside the building 72, transmissions cannot be made unless the separate external transmitter 12 is also carried along, wherefore mobility is severely compromised.

It is also conceivable that the external transmitter 12 diagrammed in FIG. 6(b) could be used by connecting it to the controller unit 70 diagrammed in FIG. 6(a).

However, if the internal transmitter 11 and the external transmitter 12 conform to the “specific low-power radio” specification, transmissions cannot be made simultaneously from both the internal transmitter 11 and external transmitter 12 on the same radio.

That is, in the case where the internal transmitter 11 has begun transmitting, having been driven earlier than the external transmitter 12, the external transmitter 12 cannot transmit. Conversely, in the case where the external transmitter 12 has begun transmitting, having been driven earlier than the internal transmitter 11, the internal transmitter 11 cannot transmit.

Let it be assumed, for example, that the example transmitter 12 diagrammed in FIG. 6(b) has been connected by cable to the controller unit 70 diagrammed in FIG. 6(a), the controller unit 70 located inside the building 72, and the example transmitter 12 located outside the building 72.

When, thereupon, the internal transmitter 11 has begun transmitting, having been driven earlier than the example transmitter 12, a radio wave transmitted from the internal transmitter 11 will be attenuated or shielded by the walls or roof of the building 72, making it very difficult to effect transmission to the work machine 13.

Thereupon, the first object of the present invention is to be able to remotely control a work machine, in a definite manner, irrespective of whether the controller unit is used outdoors or indoors.

Now, there is a desire to use the controller unit 70 in cases where, in FIG. 6(a), the distance from the controller unit 70 to the work machine 13 is a long distance of from 1000 to 3000 meters.

In that case, in order to transmit a radio signal Se from the controller unit 70 to the work machine 13 and operate the work machine 13, it is necessary to provide, in the controller unit 13, a long-range transmitter 11 capable of radio-transmitting over a long distance, and also to provide, in the work machine 13, a long-range receiver 30 capable of receiving radio signals over a long distance.

However, in order to deploy a long-range transmitter 11 in the controller unit 70, it is necessary to design a dedicated transmitter 11 that conforms to the installation space, etc., available in the controller unit 70.

This leads to a problem in that the cost of manufacturing the transmitter 11 will significantly rise compared to that of a general purpose long-range transmitter.

Similarly, in providing a long-range receiver 30 in the work machine 13, it is necessary to implement a dedicated design so as to conform to the installation space, etc., available in the work machine 13. Therefore the cost of manufacturing the receiver 30 will significantly rise compared to that of a general purpose long-range receiver. This problem arises similarly in the equipment diagrammed in FIG. 6(b) as well in the equipment diagrammed in FIG. 6(a).

Thereupon, a second object of the present invention is to achieve long-distance remote control at low manufacturing cost using general-purpose transmitters and receivers.

There are also cases where a work machine is remotely controlled while monitoring the working target and the working conditions of the work machine by viewing a monitor screen.

FIG. 7 represents a conventional remote control system for remotely controlling work machines while monitoring the working target and the working conditions of the work machines by viewing monitor screens. In the case represented in FIG. 7, two work machines, 80a and 80b, are being remotely controlled.

Here, connections are made between the work machine 80a and the controller unit 50a by two signal lines k.

The controller unit 50a outputs a control signal Se1 indicating the control inputs made by the operator manipulating levers or switches, to the work machine 80a over the signal lines k.

An on-vehicle camera 81 is provided in the work machine 80a. The on-vehicle camera 81 captures images of a working target (a pile of earth or the like being excavated, if the machine is a hydraulic shovel, for example) of the working machine 80a.

The on-vehicle camera 81 is connected to a monitor 52a via a signal line k. The monitor 52a displays the images of the working target captured by the on-vehicle camera 81.

More specifically, when the image of the working target of the work machine 80a is captured by the on-vehicle camera 81, a pickup signal Sv1 is output from the on-vehicle camera 81 and input to the monitor 52a via the signal line k. At the monitor 52a, the pickup signal Sv1 is input via the signal line k, and the image of the working target, corresponding to that input pickup signal Sv1, is displayed.

The work machine 80b and the controller unit 50b are also connected by two signal lines k.

The controller unit 50b outputs a control signal Se2 indicating the control inputs made by the operator manipulating levers or switches, to the work machine 80b over the signal line k.

A location camera 57b is located near the work machine 80b. The location camera 57a captures images showing the working conditions at the work site of the work machine 80b (the surrounding ground and slope conditions, if the machine is a bulldozer, for example).

The location camera 57b is connected to the monitor 52b via the signal line k. The monitor 52b displays the images of working conditions captured by the location camera 57b.

More specifically, when the imaged of the working conditions of the work machine 80b are captured by the location camera 57b, a pickup signal Sv2 is output from the location camera 57b and input to the monitor 52b via the signal line k. At the monitor 52b, the pickup signal Sv2 is input via the signal line k, and the images of the working conditions, corresponding to that input pickup signal Sv2, are displayed.

Thus the operator can remotely control the work machine 80a while monitoring the working target of the work machine 80a on the screen of the monitor 52a. And the operator can remotely control the work machine 80b while monitoring the working conditions of the work machine 80b on the screen of the monitor 52b.

With the equipment diagrammed in FIG. 7, it is necessary to lay multiple (4) signal lines k at the work site.

The job of laying the signal lines k at the work site is very involved, however, requiring a number of work steps proportional to the number and lengths of the signal lines k. The installation cost required is also proportional to the number and lengths of the signal lines k.

In other words, the number of signal lines is proportional to the number of work machines involved. Also, the lengths of the signal lines k become longer as the distance between the controller units and the work machines becomes greater. Thus problems arise in that the number of work steps and installation cost required to lay the signal lines at a work site where numerous work machines are remotely controlled over a long distance (1000 to 3000 meters) become prohibitive.

Thereupon, a third object of the present invention is to build a remote control system, at a work site where multiple signal lines must be laid over long distances between controller units and work machines, with fewer work steps and at lower installation cost.

### SUMMARY OF THE INVENTION

A first invention, relating to claim 1, is a work machine control system comprising a transmitter which is provided inside a controller unit, for inputting a control signal representing a control content, converting the input control signal to a radio signal and radio-transmitting it toward a work machine so that the work machine is operated according to the radio signal; wherein:

the transmitter is provided externally to the controller unit; and

provided inside of the controller unit are:

determining means for determining that the transmitter external to the controller unit is connected to the controller unit; and

switching means for switching from a configuration wherewith the control signal is input to the transmitter provided inside the controller unit to a configuration wherewith the control signal is input to the transmitter provided externally to the controller unit, when the determining means determines that the transmitter provided externally to the controller unit is connected to the controller unit.

The first invention is described with reference to FIG. 1.

According to the first invention, a transmitter 11 for inputting a control signal S0 indicating a control content, converting that input control signal S0 to a radio signal Se and radio-transmitting that toward a work machine 13, is provided internally in a controller unit 10. The work machine 13 is operated in response to the radio signal Se radio-transmitted from the transmitter 11.

Meanwhile, a transmitter 12 like the internal transmitter 11 is provided externally to the controller unit 10.

Thereupon, when the external transmitter 12 is connected to the controller unit 10, it is determined by determining means 14 inside the controller unit 10 that the external transmitter 12 is connected to the controller unit 10.

When it is determined by the determining means 14 that the external transmitter 12 is connected to the controller unit 10, the control signal S0 is switched by switching means 15 and 16 inside the controller unit 10 from switch positions 15a and 16a where it is input to the transmitter 11 inside the controller unit 10 to switch positions 15b and 16b where it is input to the transmitter 12 provided externally to the controller unit 10.

Based on the first invention, therefore, when the controller unit 10 is being carried portably outdoors, if the external transmitter 12 is disconnected from the controller unit 10, the radio signal Se can be transmitted from the internal transmitter 11. And when the controller unit 10 is located indoors, if the external transmitter 12 is connected by cable to the controller unit 10, the radio signal Se can be transmitted from the external transmitter 12.

Thus the work machine 13 can be remotely controlled without sacrificing mobility or causing attenuation or the like, regardless of whether the controller unit 10 is carried portably outdoors or located indoors.

Moreover, when the external transmitter 12 is connected to the controller unit 10, the radio signal Se will be transmitted only from the external transmitter 12, and the radio signal Se will not be transmitted from the internal transmitter 11.

For that reason, even in cases where both the internal transmitter 11 and the external transmitter 12 conform to the “specific low-power radio” specification, the radio signal Se can be transmitted from only the external transmitter 12 without fail.

Also, because it is possible to transmit the radio signal Se only from the external transmitter 12, the radio signal Se will not result in interference on the same radio circuit.

Accordingly, based on the first invention, the work machine 13 can be remotely controlled efficiently, without wasting electric power, regardless of whether the controller unit 10 is used outdoors or indoors.

A fourth invention, relating to claim 4, is a work machine control system comprising a controller unit for outputting a control signal via a signal line, and a transmitter for inputting the control signal via the signal line, converting the input control signal to a radio signal, and radio-transmitting it out to a prescribed distance toward a work machine, so that the work machine is operated according to the radio signal; wherein:

a long-range transmitter is provided for receiving the control signal over the signal line, converting the received control signal to a radio signal, and radio-transmitting the radio signal out to a farther distance than the prescribed distance;

a long-range receiver is provided for receiving the radio signal radio-transmitted from the long-range transmitter, converting the received radio signal to the control signal, and outputting the control signal over a signal line;

the controller unit and the long-range transmitter are connected by a signal line; and

the long-range receiver and the transmitter are connected by a signal line.

The fourth invention is described with reference to FIG. 2.

Based on the fourth invention, a control signal S0 indicating a control content from a controller unit 71 is output over a signal line 90.

Also, the control signal S0 is input to the transmitter 12 via the signal line 91, and that input control signal S0 is converted to a radio signal Se and radio-transmitted out to a prescribed distance (100 to 300 meters or so) toward the work machine 13. The work machine 13 operates in response to the radio signal Se.

Thereupon, a long-range transmitter 21 is provided that inputs the control signal S0 via a signal line 90, converts that input-control signal S0 to the radio signal Se, and radio-transmits it out to a distance (3000 meters, for example) that is farther than the prescribed distance (of 100 to 300 meters) noted above.

Also, a long-range receiver 23 is provided that receives the radio signal Se radio-transmitted from the long-range transmitter 21, converts that received radio signal Se to the control signal S0, and outputs it over a signal line 91.

The controller unit 71 and long-range transmitter 21 are connected by the signal line 90, and the long-range receiver 23 and transmitter 12 are connected by the signal line 91.

Hence, based on the fourth invention, the long-range (3000 meter) radio transmissions are made between the long-range transmitter 21 and the long-range receiver 23, wherefore long-range remote control is effected. Furthermore, the long-range transmitter 21 and long-range receiver 23 are not installed either inside the controller unit 71 or inside the work machine 13, and can be provided separately from the controller unit 71 and work machine 13. Hence there is no need for a dedicated design, and general-purpose equipment can be used. Accordingly, according to the fourth invention, a general-purpose transmitter and receiver is used, and long-range remote control can be realized at low manufacturing cost.

A sixth invention, relating to claim 6, is a work machine control system comprising:

a controller unit for outputting a control signal representing a control content via a signal line;

a control signal transmitter for inputting the control signal over the signal line, converting thee input control signal to a radio control signal and radio-transmitting the radio control signal out to a prescribed distance toward a work machine;

a pickup signal receiver for receiving a radio pickup signal representing a work being done by the work machine radio-transmitted from the work machine, and converting the received radio pickup signal to a pickup signal and outputting the pickup signal over a signal line; and

a display device for inputting the pickup signal via a signal line, and displaying an image of the work being done corresponding to the input pickup signal; so that the work machine is controlled on the basis of a content of display on the display device, and the work machine is operated according to the radio control signal; wherein:

a first long-range transceiver is provided for inputting the control signal via a signal line, converting the input control signal to a radio control signal and radio-transmitting the radio control signal out to a distance that is farther than the prescribed distance, receiving a radio-transmitted radio pickup signal, and converting the received radio pickup signal to a pickup signal and outputting the pickup signal over a signal line;

a second long-range transceiver is provided for inputting the pickup signal over a signal line, converting the input pickup signal to the radio pickup signal and radio-transmitting the radio pickup signal out to a distance that is farther than the prescribed distance, receiving the radio-transmitted radio control signal, and converting the received radio control signal to the control signal and outputting the control signal over a signal line;

the controller unit, the display device, and the first transceiver are connected by signal lines; and

the second transceiver, the control signal transmitter, and the pickup signal receiver are connected by signal lines.

The sixth invention is described with reference to FIG. 5. FIG. 5 diagrams a case where two work machines 53a and 53b are remotely controlled.

Based on the sixth invention, a control signal S′e1 representing the control content is output over a signal line 92 from a controller unit 50a.

Also, the control signal S′e1 is input via a signal line 99 to a control signal transmitter 54a, and that input control signal S′e1 is converted to a radio control signal Se1 and radio-transmitted out to a prescribed distance (100 to 300 meters or so) toward the work machine 53a.

Also, at a pickup signal receiver 54b, a radio pickup signal Sv1 representing the work being done by the work machine 53a radio-transmitted from that work machine 53a is received, and that received radio pickup signal Sv1 is converted to a pickup signal S′v1 and output over a signal line 97.

Meanwhile, at a display device 52a, the pickup signal S′v1 is input via a signal line 94 and an image of the work being done corresponding to that input pickup signal S′v1 is displayed.

The controller unit 50a is manipulated based on the content displayed on the display device 52a, and the work machine 53a operates in response to the radio control signal Se1 radio-transmitted as a result of the manipulation performed on the controller unit 50a.

Thereupon, a first long-range transceiver 51 is provided that inputs the control signal S′e1 via the signal line 92, converts that input control signal S′e1 to a radio control signal Se1 and radio-transmits it out to a distance (3000 meters, for example) that is greater than the prescribed distance (100 to 300 meters), receives the radio-transmitted radio pickup signal Sv1, and converts that received radio pickup signal Sv1 to a pickup signal S′v1 and outputs it over the signal line 94.

Also, a second long-range transceiver 54 is provided that inputs the pickup signal S′v1 via the signal line 97, converts that input pickup signal S′v1 to the radio pickup signal Sv1 and radio-transmits it out to a distance (3000 meters) that is greater than the prescribed distance (100 to 300 meters), receives the radio-transmitted radio control signal Se1, and converts that received radio control signal Se1 to the control signal S′e1 and outputs it over the signal line 99.

The controller unit 50a, the display device 52a, and the first transceiver 51 are connected by the signal lines 92 and 94. The second transceiver 54, the control signal transmitter 54a, and the pickup signal receiver 54b are connected by the signal lines 99 and 97.

Hence, based on the sixth invention, radio communications are effected over a long distance (3000 meters) between the first long-range transceiver 51 and the second long-range transceiver 54, wherefore there is no need to lay signal line cables over long distances. Also, sending and receiving is done by radio between the first long-range transceiver 51 and the second long-range transceiver 54, wherefore it is possible to send and receive a number of different types of signals Se1 and Sv1 that coincides with the number of radio circuits available. In other words, there is no need to lay a number of signal lines according to the types of signal, as has been done conventionally. Also, because the first long-range transceiver 51 and the second long-range transceiver 54 are not installed either inside the controller unit 50a or inside the work machine 53a, there is no need for a dedicated design, and general-purpose equipment can be used.

Accordingly, based on the sixth invention, a remote control system can be built at a work site where conventionally it has been necessary to lay multiple signal lines over long distances between controller units and work machines, with fewer work steps and at lower installation cost.

### BRIEF DESCRIPTION OF THE DRAWINGS

FIG. 1 is a diagram of a first embodiment of the present invention;

FIG. 2 is a diagram of a second embodiment of the present invention;

FIG. 3 is a block diagram of the second embodiment of the present invention;

FIG. 4 is a diagram representing an example modification of the embodiment diagrammed in FIG. 2;

FIG. 5 is a diagram of a third embodiment of the present invention; FIGS. 6(a) and 6(b) are diagrams of prior art; and

FIG. 7 is a diagram of prior art.

### DESCRIPTION OF THE PREFERRED EMBODIMENTS

Embodiments of work machine remote control systems relating to the present invention are now described.

In these embodiments, the remote control system supposed is a remote radio control system that remotely controls, by radio, such work machines as hydraulic shovels and bulldozers.

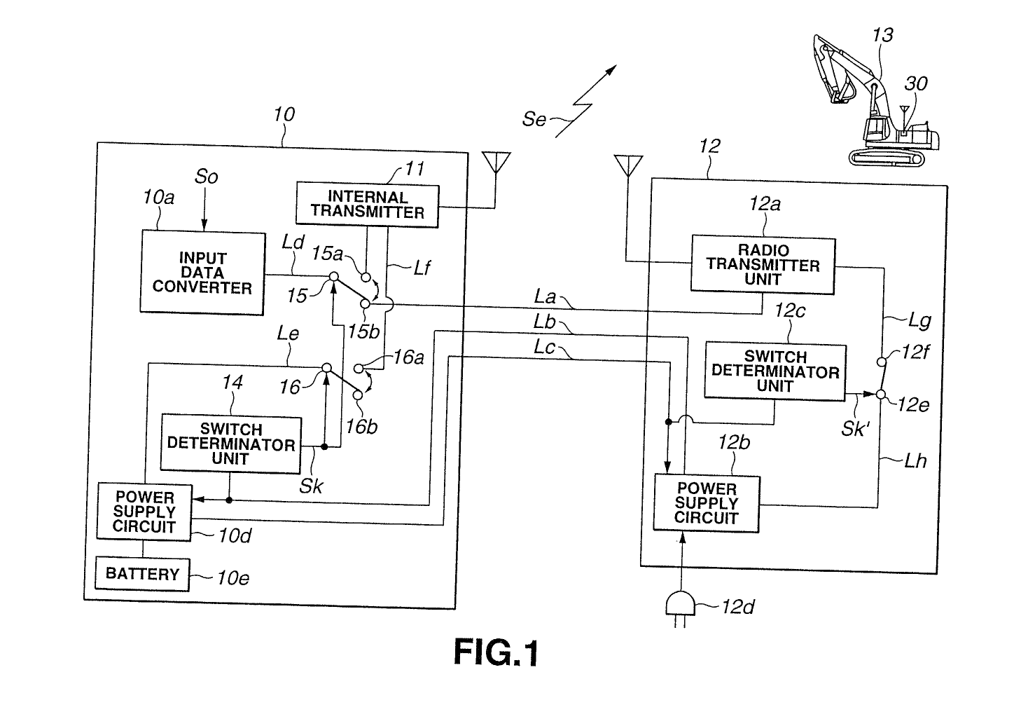

A first embodiment of the present invention is described with reference to FIG. 1.

FIG. 1 is a block diagram of the first embodiment of the present invention. In the first embodiment, it is assumed that, as diagrammed in FIG. 6(a) and 6(b), a work machine 13 is operated by radio signals Se received by a receiver 30 carried in the work machine 13.

The first embodiment diagrammed in FIG. 1 is largely configured by a controller unit 10 and an external transmitter 12 provided externally to that controller unit 10. FIG. 1 depicts how the controller unit 10 and the external transmitter 12 are electrically connected. The controller unit 10 and the external transmitter 12 are electrically connected by a control data line La and power supply lines Lb and Lc.

The control data line La is a signal line or terminal for inputting control data S0 generated by the controller unit 10 to the external transmitter 12. The power supply line Lb is a signal line or terminal for supplying power from the external transmitter 12 side to the controller unit 10 side. The power supply line Lc is a signal line or terminal for supplying power from the controller unit 10 side to the external transmitter 12 side. The control data line La and the power supply lines Lb and Lc can be configured by hardwire cables or optical fiber cables.

The configuration of the controller unit 10 is first described.

The controller unit 10 is provided internally with an input data converter 10a, internal transmitter 11, switch determinator 14, switches 15 and 16, power supply circuit 10d, and battery 10e.

The input data converter 10a inputs control signals S0 representing control inputs from the levers and switches and the like provided on a control panel on the outside of the controller unit 10, and converts those digitally to control data S0 and outputs them to the control data line Ld.

The switch 15 is connected to the control data line Ld.

The switch 15 switches the connection of the control data line Ld to either the terminal 15a or the terminal 15b, according to a switching signal Sk output from the switch determinator 14. The terminal 15a is connected to the internal transmitter 11. The terminal 15b is connected to the control data line La.

To the power supply line Le is connected the switch 16.

The switch 16 switches the power supply line Le, so as to connect either to the terminal 16a or to the terminal 16b according to the switching signal Sk output from the switch determinator 14. The terminal 16a is connected to the internal transmitter 11 via the power supply line Lf The terminal 16b is a terminal that is not electrically connected to the internal transmitter 11.

The internal transmitter 11 is driven by voltage applied via the terminal 16a and power supply line Lf Also, the internal transmitter 11 superimposes the control data S0 input via the terminal 15a onto a radio signal and radio-transmits that as the radio signal Se from the antenna toward the receiver 30 of the work machine 13.

The power supply circuit 10d generates a voltage to drive the controller unit 10. The power supply circuit 10d is connected to the power supply lines Lb and Lc.

The battery 10e is the power supply for the power supply circuit 10d.

For the power supply for the power supply circuit 10d, a power supply external to the controller unit 10 may also be used, instead of the battery 10e, by providing an adapter and connecting the controller unit 10 to the external power supply.

The switch determinator 14 is configured as a relay. The switch determinator 14 is connected to the power supply line Lb and, according to the voltage level on the power supply line Lb, determines whether the external transmitter 12 and the controller unit 10 are electrically connected by the power supply line Lb, or disconnected. When the switch determinator 14 determines that the power supply line Lb is connected, it outputs a switch signal Sk to the switches 15 and 16 to switch them to the terminals 15b and 16b, whereas, when it determines that the power line Lb is disconnected, it outputs a switch signal Sk to the switches 15 and 16 to switch them to the terminals 15a and 16a.

The configuration of the external transmitter 12 is described next.

The external transmitter 12 is configured by a radio transmitting unit 12a, switch determinator 12c, and power supply circuit 12b, with an adapter 12d provided externally.

The radio transmitting unit 12a is connected to the control data line La.

The power supply line Lg is connected to the radio transmitting unit 12a.

The adapter 12d is connected to an AC power supply external to the external transmitter 12. When the adapter 12d is connected to the AC power supply, AC power is supplied to the power supply circuit 12b.

For the power supply to the power supply circuit 12b, moreover, instead of using the AC power supply external to the external transmitter 12, with the adapter 12d connected to an AC power supply external to the external transmitter 12, provision may be made for using a battery, providing a battery inside the external transmitter 12.

The power supply line Lh is connected to the power supply circuit 12b.

The switch 12e is connected to the power supply line Lh.

The switch 12e switches the power supply line Lh so as to connect to the terminal 12f, or not to so connect, according to a switch signal Sk′ output from the switch determinator 12c. The terminal 12f is connected to the power supply line Lg.

The power supply circuit 12b converts the AC voltage input via the adapter 12d to a DC voltage that drives the radio transmitting unit 12a, and applies that DC voltage to the radio transmitting unit 12a via the power supply line Lh, switch 12e, terminal 12f and power supply line Lg. The power supply circuit 12b is connected to the power supply lines Lb and Lc.

The switch determinator 12c is connected to the power supply line Lc, and determines whether the external transmitter 12 and controller unit 10 are electrically connected by the power supply line Lc, or disconnected, according to the voltage level on the power supply line Lc. When it has determined that the power supply line Lc is connected, the switch determinator 12c outputs a switch signal Sk′ to the switch 12e to connect the power supply line Lh to the terminal 12f, but, when it determines that the power supply line Lc has been disconnected, it outputs a switch signal Sk to the switch 12e to disconnect the power supply line Lh from the terminal 12f.

The radio transmitting unit 12a, driven by voltage applied over the power supply line Lg, superimposes the control data S0 input via the control data line La onto the radio signal Se, and radio-transmits the resulting signal from the antenna toward the receiver 30 of the work machine 13.

When the controller unit 10 here is carried portably outdoors, the power supply line Lc between the controller unit 10 and external transmitter 12 is electrically disconnected.

At such time, at the external transmitter 12, in cases where a voltage is continually applied to the radio transmitting unit 12a by the power supply circuit 12b, a problem arises in that only a radio signal not containing the control data S0 is transmitted from the radio transmitting unit 12a.

Thereupon, by providing the switch determinator 12c and switch 12e to the external transmitter 12, in the system diagrammed in FIG. 1, provision is made so that, when the power supply line Lc between the controller unit 10 and external transmitter 12 is electrically disconnected, the connection between the power supply line Lg and the power supply line Lh is interrupted and no voltage is applied to the radio transmitting unit 12a.

The operation of the first embodiment is next described.

First, a description is given for the case where the controller unit 10 is located indoors.

In that case, the controller unit 10 is located inside the building 72, as diagrammed in FIG. 6(b), and the external transmitter 12 is located outside the building 72. The controller unit 10 and external transmitter 12 are electrically connected by the control data line La and the power supply lines Lb and Lc.

When the power supply line Lb is electrically connected, the controller unit 10 has power supplied thereby via the power supply line Lb.

That is, the power supply circuit 12b inside the external transmitter 12 is connected by the power supply line Lb to the power supply circuit 10d inside the controller unit 10. Therefore, the controller unit 10 will be put in a condition wherein it is driven not only with the battery 10e as the power supply, but also by the voltage applied via the adapter 12d, power supply circuit 12b, power supply line Lb, and power supply circuit 10d.

At the switch determinator 14, a determination is made, from the voltage level on the power supply line Lb, that the external transmitter 12 and controller unit 10 are electrically connected by the power supply line Lb. As a consequence, the switch determinator 14 outputs the switch signal Sk to cause the switches 15 and 16 to switch to the terminals 15b and 16b.

Therefore, the control data S0 is input via the control data line Ld, terminal 15b, and control data line La to the radio transmitting unit 12a in the external transmitter 12. Meanwhile, a state is entered wherein the control data S0 are not input to the internal transmitter 11 inside the controller unit 10. A state is also entered wherein the drive voltage generated in the internal transmitter power supply circuit 10b is not applied to the internal transmitter 11.

Meanwhile, at the switch determinator 12c inside the external transmitter 12, a determination is made, from the voltage level on the power supply line Lc, that the external transmitter 12 and controller unit 10 are electrically connected by the power supply line Lc. As a consequence, the switch determinator 12c outputs the switch signal Sk′ to the switch 12e to connect the power supply line Lh to the terminal 12f.

Thus the radio transmitting unit 12a inside the external transmitter 12 will be driven by a voltage applied via the adapter 12d, power supply circuit 12b, power supply line Lh, switch 12e, terminal 12f, and power supply line Lg.

Furthermore, the power supply circuit 10d inside the controller unit 10 is connected by the power supply line Lc to the power supply circuit 12b inside the external transmitter 12. Therefore, the radio transmitting unit 12a inside the external transmitter 12 will enter a state wherein it is driven by a voltage applied via the battery 10e inside the controller unit 10, the power supply circuit 10d, the power supply line Lc, the power supply circuit 12b, the power supply line Lh, the switch 12e, the terminal 12f, and the power supply line Lg.

The radio transmitting unit 12a inside the external transmitter 12 is driven in this manner. Thereupon, the radio transmitting unit 12a superimposes the control data S0 input over the control data line La onto the radio signal and radio-outputs it as the radio signal Se from the antenna toward the receiver 30 in the work machine 13. The receiver 30 in the work machine 13 receives that radio signal Se, and operates the work machine 13 according to the control data S0 superimposed on the radio signal Se.

Meanwhile, no voltage is applied to the internal transmitter 11, and the control data S0 are not input thereto, wherefore no radio signal Se will be transmitted from the internal transmitter 11.

Thus, if the external transmitter 12 is connected by cable to the controller unit 10 when the controller unit 10 is located indoors, the radio signal Se will be transmitted from the external transmitter 12. Not only so, but when the external transmitter 12 is connected to the controller unit 10, the radio signal Se will only be transmitted from the external transmitter 12, and the radio signal Se will not be transmitted from the internal transmitter 11. Therefore, the radio signal Se can definitely be transmitted from the external transmitter 12 only, even when both the internal transmitter 11 and external transmitter 12 are transmitters that conform to the “specific low-power radio” specification.

Next, a description is given for the case where the controller unit 10 is carried portably outdoors.

In this case, the control data line La and the power supply lines Lb and Lc between the controller unit 10 and the external transmitter 12 are electrically disconnected, as diagrammed in FIG. 6(a).

When the power supply line Lb is electrically disconnected, the controller unit 10 ceases to be powered via the power supply line Lb.

Therefore, in the switch determinator 14, it is determined from the voltage level on the power supply line Lb that the power supply line Lb is electrically disconnected. As a consequence, the switch determinator 14 outputs a switch signal Sk to the switches 15 and 16 to switch over to the terminals 15a and 16a.

As a consequence, the control data S0 are input to the internal transmitter 11 via the control data line Ld and terminal 15a. Also, a state is entered wherein the control data S0 are not input to the radio transmitting unit 12a inside the external transmitter 12.

Also, the drive voltage generated in the internal transmitter power supply circuit 10b is applied to the internal transmitter 11 via the power supply line Le, the terminal 16a, and the power supply line Lf.

The internal transmitter 11 inside the controller unit 10 is driven in this manner. Thereupon, the internal transmitter 11 superimposes the control data S0 input via the terminal 15a onto the radio signal Se and radio-transmits it as the radio signal Se from the antenna toward the receiver 30 in the work machine 13. The receiver 30 in the work machine 13 receives that radio signal Se, and the work machine 13 operates according to the control data S0 superimposed on the radio signal Se.

Meanwhile, in the switch determinator 12c inside the external transmitter 12, a determination is made from the voltage level on the power supply line Lc that the external transmitter 12 and controller unit 10 are not electrically connected by the power supply line Lc. As a consequence, the switch determinator 12c outputs a switch signal Sk′ to the switch 12e to disconnect the power supply line Lh from the terminal 12f.

Thus voltage will cease being applied to the radio transmitting unit 12a inside the external transmitter 12.

Thus the transmission of the radio signal not containing the control data S0 from the radio transmitting unit 12a will cease.

In this way, when the controller unit 10 is carried portably outdoors, the external transmitter 12 can be disconnected from the controller unit 10 so that the work machine 13 can be remotely controlled with good mobility.

According to the first embodiment described in the foregoing, whether the controller unit 10 is carried portably outdoors or located indoors, the work machine 13 can be remotely controlled without losing mobility and without the occurrence of attenuation or the like. Not only so, but when the external transmitter 12 is connected to the controller unit 10, the radio signal Se is transmitted only from the external transmitter 12, and the radio signal Se will not then be transmitted from the internal transmitter 11. Therefore, the radio signal Se can definitely be transmitted from the external transmitter 12 only, even when both the internal transmitter 11 and external transmitter 12 are transmitters that conform to the “specific low-power radio” specification.

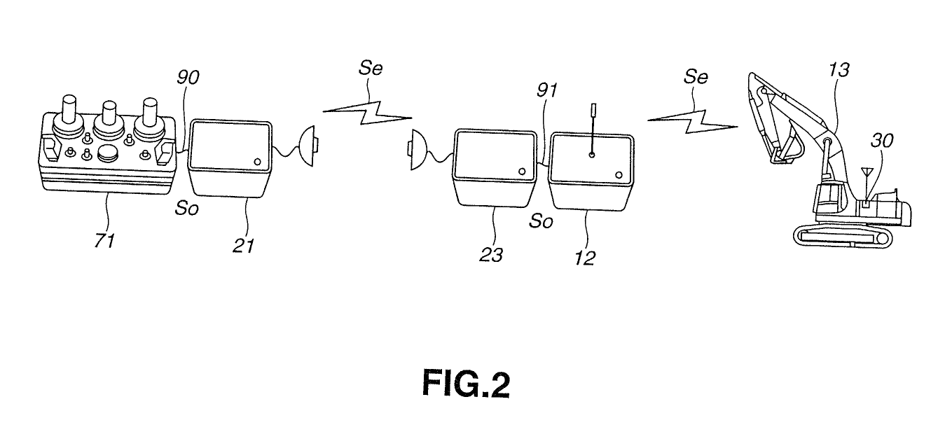

A second embodiment of the present invention is described next, making reference to FIG. 2.

The controller unit 71 and transmitter 12 in this second embodiment have the same functions as the controller unit 71 and transmitter 12 diagrammed in FIG. 6(b).

Specifically, the controller unit 71 outputs a control signal S0 over a signal line 90. And the transmitter 12 inputs the control signal S0 via the signal line 91, superimposes it on a radio signal, and radio-transmits that as the radio signal Se toward the receiver 30 in the work machine 13. The transmitter 12 here is a short-range transmitter that conforms to the “specific low-power radio” specification. The transmitter 12 can only transmit the radio signal Se over a short distance of from 100 to 300 meters or so.

Over against this is provided a pair of devices, namely a long-range transmitter 21 and long-range receiver 23, capable of radio communications over long distances (out to a distance of 3000 meters or so). This pair of devices, namely the long-range transmitter 21 and long-range receiver 23, can utilize general-purpose milliwave radio devices employing a millimeter wave (having a frequency of 50 GHz or so) as the carrier signal.

That is, the long-range transmitter 21 inputs the control signal S0 over the signal line 90, and superimposes that input control signal S0 onto a radio signal which is then radio-transmitted as the radio signal Se out to a long distance (3000 meters).

Meanwhile, the long-range receiver 23 receives the radio signal Se radio-transmitted from the long-range transmitter 21, and extracts the control signal S0 superimposed on the received radio signal Se and outputs it over the signal line 91.

The controller unit 71 and long-range transmitter 21 are connected by the signal line 90, and the long-range receiver 23 and transmitter 12 are connected by the signal line 91.

The remote control equipment diagrammed in FIG. 2 thus operates as described below.

That is, when the levers and switches and the like on the control panel on the outside of the controller unit 71 are manipulated, a control signal S0 indicating the content of such control inputs is input from the controller unit 71 to the long-range transmitter 21 via the signal line 90. Thus the radio signal Se wherein the control signal S0 is superimposed coming from the long-range transmitter 21 is radio-transmitted out to a long distance (3000 meters or so). At the long-range receiver 23, the radio signal Se radio-transmitted from the long-range transmitter 21 is received, and the control signal S0 superimposed on the radio signal Se is extracted and output to the transmitter 12 via the signal line 91. At the transmitter 12, the control signal S0 is input via the signal line 91, and the control signal S0 is superimposed on the radio signal and radio-transmitted as the radio signal Se out to a short distance (100 to 300 meters or so) toward the receiver 30 in the work machine 13. At the receiver 30 of the work machine 13, the radio signal Se is received, and the control signal S0 superimposed on the radio signal Se is extracted, whereupon the work machine 13 operates according to the control signal S0.

Thus, based on the second embodiment, radio transmissions are conducted over long distances (3000 meters) between a long-range transmitter 21 and a long-range receiver 23, wherefore remote control can be effected over a longer distance than when a short-range transmitter 12 is used by itself.

Not only so, but the long-range transmitter 21 and long-range receiver 23 need not be installed inside the controller unit 71 or inside the work machine 13, but can be provided separately from the controller unit 71 and work machine 13. Therefore no dedicated design is required, and general-purpose milliwave radio equipment can be used. Accordingly, as based on this embodiment, long-distance remote control can be implemented at low manufacturing cost using general-purpose transmitters and receivers.

In the second embodiment, as described in the foregoing, milliwaves are used for the carrier signal, but microwaves may also be used.

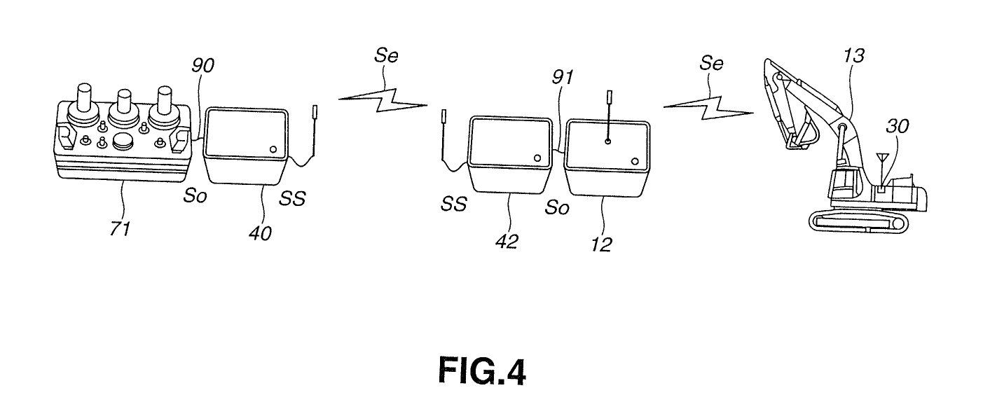

FIG. 4 is an example of a modification of FIG. 2 wherein microwave radio equipment is used.

As diagrammed in FIG. 4, instead of the long-range transmitter 21 and long-range receiver 23 pair diagrammed in FIG. 2, a pair consisting of an SS (spectrum spread) radio transmitter 40 and SS radio receiver 42 is provided. This SS radio transmitter 40 and SS radio receiver 42 pair consists of general-purpose radio equipment that employs microwaves as the carrier signal.

When this SS radio transmitter 40 and SS radio receiver 42 pair is employed, radio transmissions can be made over long distances (out to 1000 meters or so).

Accordingly, as with the remote control equipment diagrammed in FIG. 2, long-distance remote control can be implemented at low manufacturing cost using general-purpose transmitters and receivers.

Not only so, but when SS radio is employed, high-speed communication (256 Kbps) is possible, making it possible to communicate large volumes of information at high speed.

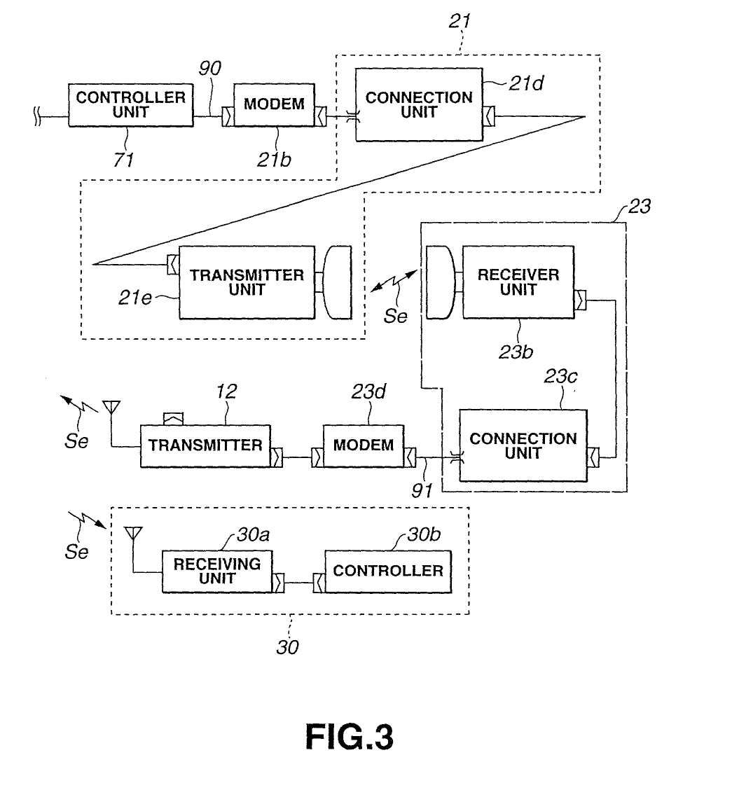

FIG. 3 is a block diagram of an example configuration of the remote control equipment diagrammed in FIG. 2.

As diagrammed in FIG. 3, the controller unit 71 and long-range transmitter 21 are connected by the signal line 90 via a modem 21b. Also, the long-range receiver 23 and the transmitter 12 are connected by the signal line 91 via a modem 23d.

The long-range transmitter 21 is a serial interface configured by a connection unit 21d and a transmitter unit 21e. An RS 232C interface is used, for example.

The control signal S0 is modulated by the modem 21b and input to the connection unit 21d. The control signal S0 is input via that connection unit 21d to the transmitter unit 21e. In the transmitter unit 21e, the control signal S0 is superimposed as serial data onto the carrier signal and transmitted as the radio signal Se.

The long-range receiver 23 is a serial interface configured by a receiver unit 23b and a connection unit 23c.

In the receiver unit 23b, the serial data superimposed on the radio signal Se are extracted as the control signal S0 and input to the connection unit 23c. The control signal S0 is input via that connection unit 23c to the modem 23d.

The control signal S0 is demodulated by the modem 23d and input to the transmitter 12.

The transmitter 12 superimposes the control signal S0 input via the modem 23d onto the radio signal Se and transmits the resulting signal toward the receiver 30 in the work machine 13.

The receiver 30 is configured by a receiving unit 30a and a controller 30b.

In the receiving unit 30a, the control signal S0 is extracted from the radio signal Se radio-transmitted from the transmitter 12 and input to the controller 30b.

The controller 30b controls the drive of the work machine 13 based on the control signal S0. The work machine 31 operates in the manner described above.

In the system diagrammed in FIG. 3, general-purpose devices can be used for the modems 21b and 23d.

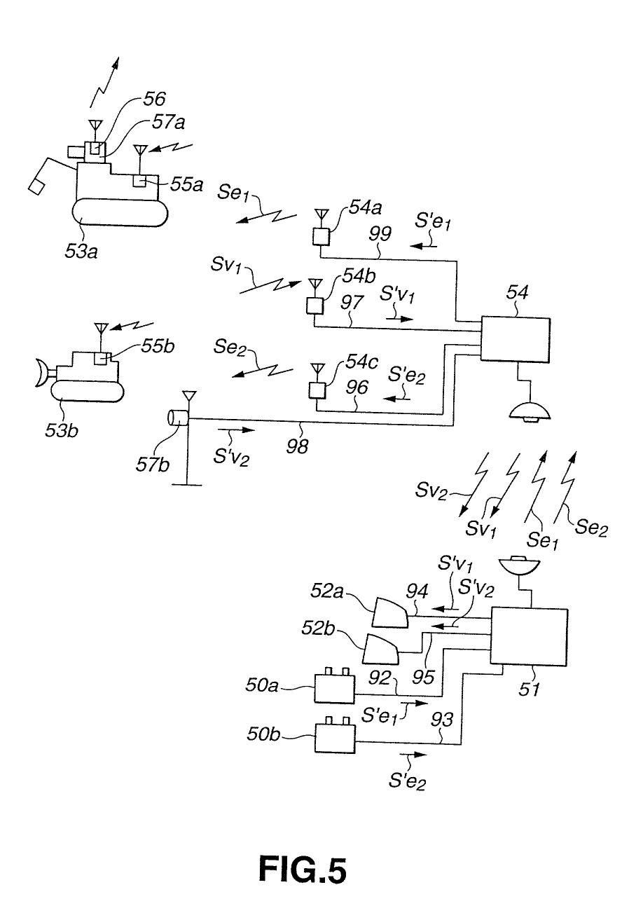

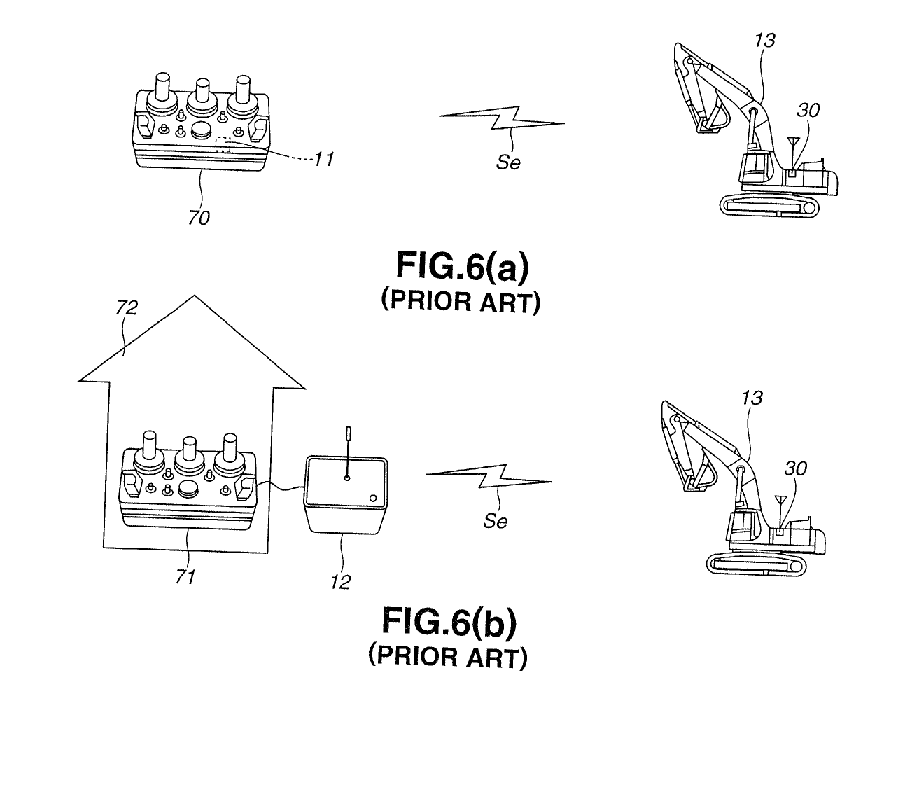

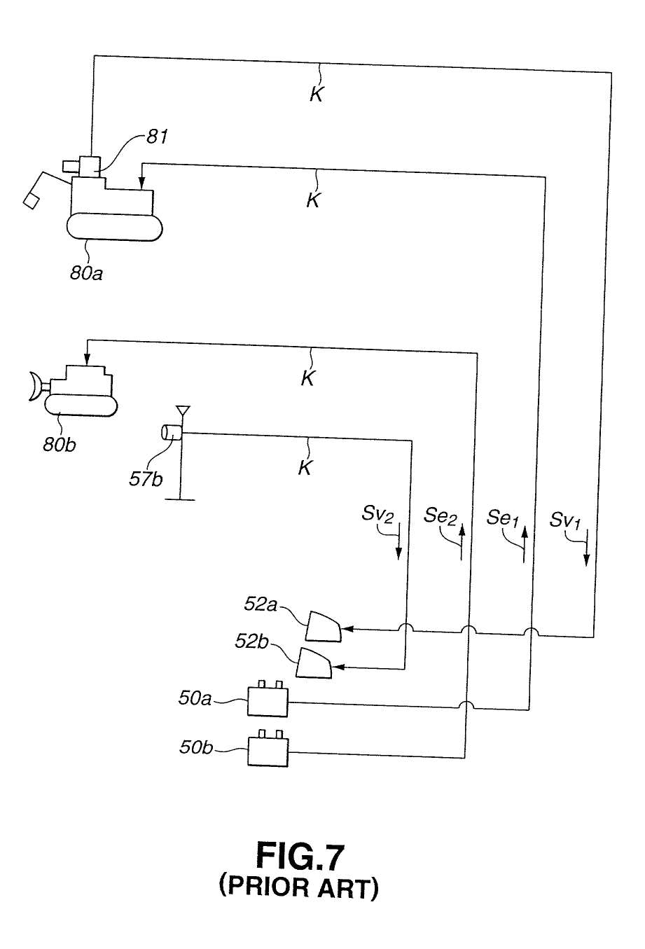

A third embodiment is now described with reference to FIG. 5.

In FIG. 5, a case is presumed wherein two work machines 53a and 53b are remotely controlled while monitoring the work being done and the working conditions on display screens on monitors 52a and 52b.

The controller unit 50a, monitor 52a, control signal transmitter 54a, and pickup signal receiver 54b are provided in correspondence with the work machine 53a. By the same token, the controller unit 50b, monitor 52b, control signal transmitter 54c, and location camera 57b are provided in correspondence with the work machine 53b.

In the work machine 53a are carried an on-board camera 57a and pickup signal transmitter 56. Images of the work being done by the work machine 53a are captured by the on-board camera 57a. If the work machine 53a is a hydraulic shovel, for example, a dirt mound that is being excavated might be video-captured by the on-board camera 57a. The pickup signal S′v1 of the on-board camera 57a is output to the pickup signal transmitter 56. The pickup signal transmitter 56 superimposes the pickup signal S′v1 onto a radio signal and radio-transmits the resulting signal as the radio pickup signal Sv1 toward the pickup signal receiver 54b.

A control signal receiver 55a is carried on board the work machine 53a. That control signal receiver 55a receives the radio control signal Se1 radio-transmitted from the control signal transmitter 54a.

A control signal receiver 55b is carried on board the work machine 53b. That control signal receiver 55b receives the radio control signal Se2 radio-transmitted from the control signal transmitter 54c.

The location camera 57b is installed near the work machine 53b. Images showing the working conditions of the work machine 53b are captured by the location camera 57b. If the work machine 53b is a bulldozer, for example, the condition of the surrounding ground and the slope of the ground are captured by the location camera 57b. The pickup signal S′v2 of the location camera 57b is output over a signal line 98.

The controller units 50a and 50b here are provided with functions equivalent to those of the controller unit 71 indicated in FIG. 2. Also, the control signal transmitters 54a and 54c, and the pickup signal transmitter 56, is provided with functions equivalent to those of the transmitter 12 indicated in FIG. 2. In other words, the control signal transmitters 54a and 54c and the pickup signal transmitter 56 are short-range transmitters that conform to the “specific low-power radio” specification. These transmitters are only capable of transmitting radio signals a short distance such as 100 to 300 meters or so.

The controller unit 50a outputs the control signal S′e1 over the signal line 92. The control signal transmitter 54a corresponding to that controller unit 50a inputs the control signal S′e1 via the signal line 99, and superimposes that control signal S′e1 onto the radio signal and radio-transmits that as the radio control signal Se1 toward the receiver 55a in the work machine 53a.

Similarly, the controller unit 50b outputs the control signal S′e2 over a signal line 93. The control signal transmitter 54c corresponding to that controller unit 50b inputs the control signal S′e2 via a signal line 96, and superimposes that input control signal S′e2 onto a radio signal and radio-transmits that as the radio control signal Se2 toward the receiver 55b in the work machine 53b.

The pickup signal receiver 54b receives the radio pickup signal Sv1, and extracts the pickup signal S′v1 from that radio pickup signal Sv1 and outputs it over the signal line 97. The monitor 52a corresponding to the pickup signal receiver 54b inputs the pickup signal S′v1 via the signal line 94 and displays images of the work being done by the work machine 53a corresponding to that pickup signal S′v1 on the display screen.

Similarly, the location camera 57b outputs the pickup signal S′v2 over the signal line 98. The monitor 52b corresponding to the location camera 57b inputs the pickup signal S′v2 via a signal line 95, and displays the images of the working conditions of the work machine 53b corresponding to the pickup signal S′v2 on the display screen.

Thereupon, as in the remote control system diagrammed in FIG. 2, a pair of devices capable of radio communications over long distances (out to 3000 meters or so), namely a radio transceiver 51 and a radio transceiver 54, is provided. For this radio transceiver 51 and radio transceiver 54 pair, general-purpose milliwave radio equipment can be used which employs millimeter waves (with a frequency of 50 GHz or so) as the carrier signal.

The radio transceivers 51 and 54 have four or more radio circuits. Therefore, the radio control signal Se1, radio control signal Se2, radio pickup signal Sv1, and radio pickup signal Sv2 are allotted to frequency bands.

More specifically, the radio transceiver 51 inputs the control signal S′e1 via the signal line 92, and superimposes that input control signal S′e1 onto a radio signal which it radio-transmits as the radio control signal Se1 out to a long distance (3000 meters), and also inputs the control signal S′e2 via the signal line 93, and superimposes that input control signal S′e2 onto a radio signal which it radio-transmits as the radio control signal Se2 out to a long distance (3000 meters). The radio transceiver 51 also receives the radio-transmitted radio pickup signal Sv1, extracts the pickup signal S′v1 from that received radio pickup signal Sv1 and outputs it over the signal line 94, and also receives the radio-transmitted radio pickup signal Sv2, and extracts the pickup signal S′v2 from that received radio pickup signal Sv2 and outputs it over the signal line 95.

The radio transceiver 54, meanwhile, inputs the pickup signal S′v1 via the signal line 97, and superimposes that received pickup signal S′v1 onto a radio signal and radio-transmits the resulting signal as the radio pickup signal Sv1 out to a long distance (3000 meters), and also inputs the pickup signal S′v2 via the signal line 98, and superimposes that input pickup signal S′v2 onto a radio signal and radio-transmits the resulting signal as the radio pickup signal Sv2 out to a long distance (3000 meters). The radio transceiver 54 also receives the radio-transmitted radio control signal Se1, and extracts the control signal S′e1 from that received radio control signal Se1 and outputs it over the signal line 99, and also receives the radio-transmitted radio control signal Se2, and extracts the control signal S′e2 from that received radio control signal Se2 and outputs it over the signal line 96.

Also, the controller unit 50a, controller unit 50b, display device 52a, and display device 52b are respectively connected to the radio transceiver 51 by signal line 92, signal line 93, signal line 94, and signal line 95, while the pickup signal receiver 54b, location camera 57b, control signal receiver 54a, and control signal receiver 54c are respectively connected to the radio transceiver 54 by the signal line 97, signal line 98, signal line 99, and signal line 96.

Hence the remote control system diagrammed in FIG. 5 will operate as described below.

Specifically, images of the work being done by the work machine 53a are captured by the on-board camera 57a on board the work machine 53a. This pickup signal S′v1 is radio-transmitted out to a short distance (100 to 300 meters) as the radio pickup signal Sv1 superimposed on a radio signal from the pickup signal transmitter 56 of the work machine 53a, and received by the pickup signal receiver 54b. In the pickup signal receiver 54b, the pickup signal S′v1 is extracted from the received radio pickup signal Sv1 and input to the radio transceiver 54 via the signal line 97. Thus the radio pickup signal Sv1 with the pickup signal S′v1 superimposed from the radio transceiver 54 is radio-transmitted out to a long distance (3000 meters or so). At the radio transceiver 51, the radio pickup signal S′v1 radio-transmitted from the radio transceiver 54 is received, and the pickup signal S′v1 superimposed on the radio pickup signal Sv1 is output to the monitor 52a via the signal line 94. Thus images of the work being done by the work machine 53a are displayed on the monitor 52a.

An operator can verify the work currently being done by the work machine 53a from the display screen of the monitor 52a.

Thereupon, the levers and switches and the like on the control panel on the outside of the controller unit 50a are manipulated. A control signal S′e1 indicating the content of such control inputs is input by the radio transceiver 51 from the controller unit 50a via the signal line 92. Thus the radio control signal Se1 with the control signal S′e1 superimposed from the radio transceiver 51 is radio-transmitted out to a long distance (3000 meters or so). At the radio transceiver 54, the radio control signal Se1 radio-transmitted from the radio transceiver 51 is received, and the control signal S′e1 superimposed on the radio control signal Se1 is output to the control signal transmitter 54a via the signal line 99. At the control signal transmitter 54a, the control signal S′e1 is input via the signal line 99, and the control signal S′e1 is superimposed on a radio signal and radio-transmitted as the radio control signal Se1 out to a short distance (100 to 300 meters or so) toward the control signal receiver 55 a of the work machine 53a. At the receiver 55a of the work machine 53a, the radio control signal Se1 is received, and the work machine 53 a operates according to the control signal S′e1 superimposed on the radio control signal Se1.

As described in the foregoing, the controller unit 50a is manipulated on the bases of the content of the display on the display device 52a, and the work machine 53a operates according to the radio control signal Se1 radio-transmitted as a result of manipulating the controller unit 50a.

Similarly, images of the working conditions of the work machine 53b are captured by the location camera 57b. This pickup signal S′v2 is input to the radio transceiver 54 via the signal line 98. Thus the radio pickup signal Sv2 with the pickup signal S′v2 superimposed from the radio transceiver 54 is radio-transmitted out to a long distance (3000 meters or so). At the radio transceiver 51, the radio pickup signal Sv2 radio-transmitted from the radio transceiver 54 is received, and the superimposed pickup signal S′v2 in the radio pickup signal Sv2 is output to the monitor 52b via the signal line 95. Thus images of the working conditions of the work machine 53b are displayed on the monitor 52b.

An operator can verify the status of work currently being done by the work machine 53b from the display screen of the monitor 52b.

Thereupon, the levers and switches and the like on the control panel on the outside of the controller unit 50b are manipulated. A control signal S′e2 indicating the content of such control inputs is input to the radio transceiver 51 from the controller unit 50b via the signal line 93. Thus the radio control signal Se2 with the superimposed control signal S′e2 from the radio transceiver 51 is radio-transmitted out to a long distance (3000 meters or so). At the radio transceiver 54, the radio control signal Se2 radio-transmitted from the radio transceiver 51 is received, and the superimposed control signal S′e2 in the radio control signal Se2 is output to the control signal transmitter 54c via the signal line 96. At the control signal transmitter 54c, the control signal S′e2 is input via the signal line 96, and the control signal S′e2 is superimposed on a radio signal and radio-transmitted as the radio control signal Se2 out to a short distance (100 to 300 meters or so) toward the control signal receiver 55b of the work machine 53b. At the control signal receiver 55b of the work machine 53b, the radio control signal Se2 is received, and the work machine 53b operates according to the superimposed control signal S′e2 in the radio control signal Se2.

As described in the foregoing, the controller unit 50b is manipulated on the bases of the content of the display on the display device 52b, and the work machine 53b operates according to the radio control signal Se2 radio-transmitted as a result of those manipulations on the controller unit 50b.

Thus, based on the third embodiment, radio communications are implemented over a long distance (3000 meters) between the radio transceiver 51 and the radio transceiver 54, wherefore there is no need to lay signal line cables over long distances. Also, because transmission and reception between the radio transceiver 51 and the radio transceiver 54 are done by radio, different types of signals can be sent and received, by precisely the number of radio circuits, that is, to the extent that the signal types Se1, Se2, Sv1, and Sv2 can be allotted to frequency bands. In other words, there is no necessity, as conventionally, of laying more signal lines as the types of signals increase. Not only so, but the radio transceiver 51 and radio transceiver 54 are not installed inside the controller units 50a and 50b or inside the work machines 53a and 53b, but can be provided separately from those controller units 50a and 50b and work machines 53a and 53b. Thus no dedicated design is necessary, and general-purpose milliwave radio equipment can be used.

Accordingly, based on the third embodiment, a remote control system can be built with fewer work steps and lower installation cost at a work site where conventionally multiple signal lines had to be laid over long distances between the controller units and the work machines.

In the third embodiment as described above, milliwaves are used for the carrier signal, but microwaves may be used instead. Specifically, microwave radio equipment equivalent to the SS radio equipment 40 and 42 indicated in FIG. 4 can be used in place of the radio transceivers 51 and 54 indicated in FIG. 5.

With the remote control system diagrammed in FIG. 5, it is also possible to add, change, or remove configuring elements.

An example of a modification of the remote control system diagrammed in FIG. 5 is now described.

Specifically, in FIG. 5, a case is presumed wherein two work machines 53a and 53b are remotely controlled, but an embodiment wherein only one work machine 53a is remotely controlled is also possible.

In that case, the equipment provided in correspondence with the work machine 53b in FIG. 5 would be eliminated, namely the controller unit 50b, the monitor 52b, the signal lines 93 and 95 corresponding thereto, the control signal transmitter 54c, the location camera 57b, the signal lines 96 and 98 corresponding thereto, and the control signal receiver 55b carried on board the work machine 53b.

Alternatively, an embodiment wherein only the other work machine 53b is remotely controlled is also possible.

In that case, the equipment provided in correspondence with the work machine 53a in FIG. 5 could be eliminated, namely the controller unit 50a, the monitor 52a, the signal lines 92 and 94 corresponding thereto, the control signal transmitter 54a, the pickup signal receiver 54b, the signal lines 99 and 97 corresponding thereto, the on-board camera 57a carried on board the work machine 53a, the pickup signal transmitter 56, and the control signal receiver 55a.

In the system diagrammed in FIG. 5, furthermore, the two work machines 53a and 53b are remotely controlled while monitoring display screens on the monitors 52a and 52b. In cases where it is not necessary to monitor the display screens on the monitors 52a and 52b, however, the monitors 52a and 52b can be removed along with the configuring elements related thereto, namely the signal lines 94, 95, 97, and 98, the pickup signal receiver 54b, the location camera 57b, the on-board camera 57a, and the pickup signal transmitter 56.

The modified configuration example described below is also possible in the system diagrammed in FIG. 5.

That is, whereas images of the working conditions of the work machine 53b are captured by the location camera 57b in FIG. 5, instead thereof, an on-board camera like that of the work machine 53a may be carried on board the work machine 53b. In that case, an on-board camera and pickup signal transmitter equivalent to the on-board camera 57a and pickup signal transmitter 56 would be carried on board the work machine 53b. Similarly, a pickup signal receiver equivalent to the pickup signal receiver 54b would be connected via a signal line to the radio transceiver 54.

Furthermore, the on-board camera may be provided on the vehicle body of the work machine or on a working member of the work machine. It can be provided on the dozer apparatus of a bulldozer or on the bucket of a hydraulic shovel, for example.

In the system diagrammed in FIG. 5, furthermore, the on-board camera 57a carried on board the work machine 53a may also be remotely controlled by the controller units 50a and 50b in addition to remotely controlling therewith the drives of the traveling member, swiveling member, and working member of the work machines 53a and 53b. In that case, a drive mechanism is provided in the work machine 53a for changing the shooting direction of the on-board camera 57a. That drive mechanism is controlled by the controller unit 50a, whereupon the shooting direction of the on-board camera 57a is changed.

What is claimed is:

1. A work machine control system comprising a transmitter which is provided inside a controller unit, for inputting a control signal representing a control content, converting the input control signal to a radio signal and radio-transmitting it toward a work machine so that the work machine is operated according to the radio signal; wherein:
the transmitter is provided externally to the controller unit; and
provided inside of the controller unit are:
determining means for determining that the transmitter external to the controller unit is connected to the controller unit; and
switching means for switching from a configuration wherewith the control signal is input to the transmitter provided inside the controller unit to a configuration wherewith the control signal is input to the transmitter provided externally to the controller unit, when the determining means determines that the transmitter provided externally to the controller unit is connected to the controller unit.

2. The work machine control system according to claim 1, comprising a transmitter power supply for driving the transmitter provided externally to the controller unit, provided in correspondence with the transmitter provided externally to the controller unit; and a controller unit power supply for driving the controller unit, provided in correspondence with the controller unit; wherein:
a power supply terminal or a power supply signal line for supplying power from the transmitter power supply to the controller unit is provided externally to the transmitter;
the determining means determines that the power supply terminal or the power supply signal line has been electrically connected to the controller unit; and
the controller unit and the transmitter provided externally to the controller unit are driven by the transmitter power supply or the controller unit power supply when it is determined by the determining means that the power supply terminal or the power supply signal line has been electrically connected to the controller unit.

3. The work machine control system according to claim 1, wherein the controller unit is located inside a building; and the transmitter external to the controller unit is located externally to the building.

4. A work machine control system comprising a controller unit for outputting a control signal via a signal line, and a transmitter for inputting the control signal via the signal line, converting the input control signal to a radio signal, and radio-transmitting it out to a prescribed distance toward a work machine, so that the work machine is operated according to the radio signal; wherein:
a long-range transmitter is provided for receiving the control signal over the signal line, converting the received control signal to a radio signal, and radio-transmitting the radio signal out to a farther distance than the prescribed distance;
a long-range receiver is provided for receiving the radio signal radio-transmitted from the long-range transmitter, converting the received radio signal to the control signal, and outputting the control signal over a signal line;
the controller unit and the long-range transmitter are connected by a signal line; and
the long-range receiver and the transmitter are connected by a signal line.

5. A work machine control system comprising a plurality of controller units for outputting a control signal via a signal line, and a plurality of transmitters for inputting the control signal via the signal line, converting the input control signal to a radio signal, and radio-transmitting the radio signal out to a prescribed distance toward a work machine, so that a plurality of work machines are operated according to the radio signal; wherein:
a long-range transmitter is provided for receiving a plurality of control signals, respectively, over a plurality of signal lines, converting the plurality of input control signals, respectively, to a plurality of radio signals, and radio-transmitting the radio signals out to a farther distance than the prescribed distance;
a long-range receiver is provided for receiving the plurality of radio signals radio-transmitted from the long-range transmitter, converting the plurality of received radio signals to the plurality of control signals, and outputting the plurality of control signals over a plurality of signal lines;
the plurality of controller units and the long-range transmitter are connected by a plurality of signal lines; and
the long-range receiver and the plurality of transmitters are connected by a plurality of signal lines.

6. A work machine control system comprising:
a controller unit for outputting a control signal representing a control content via a signal line;
a control signal transmitter for inputting the control signal over the signal line, converting thee input control signal to a radio control signal and radio-transmitting the radio control signal out to a prescribed distance toward a work machine;
a pickup signal receiver for receiving a radio pickup signal representing a work being done by the work machine radio-transmitted from the work machine, and converting the received radio pickup signal to a pickup signal and outputting the pickup signal over a signal line; and
a display device for inputting the pickup signal via a signal line, and displaying an image of the work being done corresponding to the input pickup signal; so that the work machine is controlled on the basis of a content of display on the display device, and the work machine is operated according to the radio control signal; wherein:
a first long-range transceiver is provided for inputting the control signal via a signal line, converting the input control signal to a radio control signal and radio-transmitting the radio control signal out to a distance that is farther than the prescribed distance, receiving a radio-transmitted radio pickup signal, and converting the received radio pickup signal to a pickup signal and outputting the pickup signal over a signal line;
a second long-range transceiver is provided for inputting the pickup signal over a signal line, converting the input pickup signal to the radio pickup signal and radio-transmitting the radio pickup signal out to a distance that is farther than the prescribed distance, receiving the radio-transmitted radio control signal, and converting the received radio control signal to the control signal and outputting the control signal over a signal line;
the controller unit, the display device, and the first transceiver are connected by signal lines; and
the second transceiver, the control signal transmitter, and the pickup signal receiver are connected by signal lines.

7. A work machine control system comprising:
a controller unit for outputting a control signal via a signal line;
a control signal transmitter for inputting the control signal via a signal line, and converting the input control signal to a radio control signal and radio-transmitting the radio control signal out to a prescribed distance toward a work machine;
image pickup means for capturing an image of a state of work of the work machine and outputting a pickup signal over a signal line; and
a display device for inputting the pickup signal via a signal line, and displaying the image of the state of work corresponding to the input pickup signal;
so that the work machine is controlled on the basis of a content of display on the display device; wherein:
the work machine is operated according to the radio control signal;
a first long-range transceiver is provided for inputting the control signal via a signal line, converting the input control signal to a radio control signal and radio-transmitting the radio control signal out to a distance that is farther than the prescribed distance, receiving a radio-transmitted radio pickup signal, and converting the received radio pickup signal to a pickup signal and outputting the pickup signal over a signal line;
a second long-range transceiver is provided for inputting the pickup signal over a signal line, converting the input pickup signal to the radio pickup signal and radio-transmitting thee radio pickup signal out to a distance that is farther than the prescribed distance, while receiving the radio-transmitted radio control signal, and converting the received radio control signal to the control signal and outputting the control signal over a signal line; and
the controller unit, the display device, and the first transceiver are connected by signal lines; and
the second transceiver, the control signal transmitter, and the image pickup means are connected by signal lines.
